(19) United States
(12) Patent Application Publication
(10) Pub. No.: US 2026/0288299 A1
(43) Pub. Date: Sep. 24, 2026

(54) SOLAR PANEL GROUND MOUNT STRUCTURE DESIGN SYSTEM

(71) Applicant: SOLAR FOUNDATIONS USA, INC., New Castle, DE (US)

(72) Inventors: Michael J. Zuritis, Ballston Lake, NY (US); Carl T. Regenauer, Saratoga Springs, NY (US)

(21) Appl. No.: 19/569,145

(22) Filed: Mar. 17, 2026

Related U.S. Application Data
(60) Provisional application No. 63/776,759, filed on Mar. 24, 2025.

(51) Int. Cl. G06F 3/04815; G06F 3/0482; G06F 3/04845; G06F 3/04855; G06F 30/12; G06F 30/13; G06T 19/00; G06F 111/04

(52) U.S. Cl. CPC G06F 3/04815; G06F 3/0482; G06F 3/04845; G06F 3/04855; G06F 30/12; G06F 30/13; G06T 19/006; G06F 2111/04; G06T 2219/2016

(57) ABSTRACT

A solar panel ground mount structure design system is provided. The system may include a server having a memory for storing various data related to ground mounted solar arrays and a computer system coupled to the server, wherein the computer system operates a mobile application in performing the solar panel estimations. The computer system may be programmed to measure azimuth utilizing GPS technology of the computer system, and, utilizing AR-based spatial analysis system of the computer system, measure distances for placement of a ground mounted solar panel array, measure slopes and elevation in the area of the ground mounted solar panel, and provide visual representation of the ground mounted solar panel array in a selected space for installation. The system may also generate rough order of magnitude cost estimates, perform price comparisons based on panels and racks, generate shading analysis, obtain ground contours, assess ground slope for feasibility.

### RELATED APPLICATION

This application claims priority to U.S. Provisional Patent Application No. 63/776,759 filed on Mar. 24, 2025 and titled “Solar Panel Ground Mount Structure Design System” the entirety of which incorporated by reference herein.

### FIELD

The subject matter herein relates generally to a system for designing a solar panel array. More specifically, it pertains to a system utilizing the augmented reality capabilities of a computer system to facilitate the design and visualization of a ground-mounted solar panel array.

### BACKGROUND

Renewable energy sources are becoming more popular with the rising cost of oil and other non-renewable energy resources. Solar energy is a renewable energy source that is desirable to use. One method of harnessing solar energy is to install a structural array of solar panels, or a solar array, such that the solar panels each face the sun to achieve sunlight absorption. Many solar arrays include a combination of columns that extend from the ground, horizontal rails that extend between the columns, and mounting rails or bars that are attachable above the horizontal rails. Solar panels are then attached to the mounting rails with clamps.

Conventional means of designing the structure of a ground mounted solar array includes determining the size and capacity of the solar panel system, performing a site assessment, such as, but not limited to sunlight exposure, space requirements, terrain conditions, soil conditions, local regulations and the like. Once this data is obtained, the design, cost of installation and performance of the solar array can be estimated. Typically, this is performed manually by skilled designers utilizing either manual means of calculation, or for some portions of the estimation, using various tools. None of these typical means of designing the structure of a ground mounted solar array are available in a single tool that utilizes the GPS capabilities, AR-based spatial analysis and visualization, and panoramic imaging capabilities of a mobile computing device perform an in situ structure design.

Thus, an improved solar panel ground mount structure design system would be well received in the art.

### SUMMARY

In one aspect, a method for automatically generating a digital representation of a ground mount structure for a solar panel array is provided. The method comprises receiving, by a user interface of a computer system, at least one dimensional characteristic of an intended ground mount structure. The method further comprises capturing, by a camera of the computer system, imaging information of an environment. The method further comprises receiving, by the computer system, a location in the environment. The method further comprises generating, by the computer system, the digital representation of the ground mount structure for the solar panel array using the received at least one dimensional characteristic and the received location. The method further comprises displaying, by a display of the computer system, the environment with the generated digital representation of the ground mount structure having the at least one dimensional characteristic and located at the received location.

Additionally or alternatively, receiving the location in the environment further comprises receiving, by a GPS system of the computer system, GPS information of the computer system, and using, by the computer system, the received GPS information in determining directional bearings in the generating and displaying.

Additionally or alternatively, generating the digital representation of the ground mount structure further comprises using, by the computer system, an AR-based spatial analysis system.

Additionally or alternatively, the displaying the environment with the generated digital representation of the ground mount structure further comprises rendering, by the computer system, the generated digital representation of the ground mount structure in an augmented reality version of the environment being captured in real time by the camera and displayed by the display.

Additionally or alternatively, the displaying the environment with the generated digital representation of the ground mount structure further comprises rendering, by the computer system, the generated digital representation of the ground mount structure in a virtual reality version of the environment as the imaging information is captured in real time by the camera.

Additionally or alternatively, the method further comprises receiving, by the computer system, grade and contour information of the environment, and using, by the computer system, the grade and contour information in generating the digital representation of the ground mount structure.

Additionally or alternatively, the method further comprises storing, by the computer system, the generated digital representation of the ground mount structure, loading, by the computer system, the generated and stored digital representation of the ground mount structure at the received location within the environment, and displaying, by the display of the computer system, the environment with the generated and stored digital representation of the ground mount structure at the received location.

Additionally or alternatively, the storing, by the computer system, the generated digital representation of the ground mount structure includes storing a benchmark location using the imaging captured by the camera, and the loading, by the computer system, the generated and stored digital representation of the ground mount structure at the received location within the environment includes identifying the at least one benchmark location associated with the generated digital representation of the ground mount structure using the camera.

Additionally or alternatively, the loading, by the computer system, the generated and stored digital representation of the ground mount structure at the received location within the environment includes using the camera and at least one image recognition system to automatically determine the received location.

Additionally or alternatively, the loading, by the computer system, the generated and stored digital representation of the ground mount structure at the received location within the environment includes using a GPS system or an AR-based spatial analysis system to determine the received location.

Additionally or alternatively, receiving, by the computer system, the location in the environment further comprises receiving, by the computer system, general positional reference data used in the generating the digital representation of the ground mount structure.

Additionally or alternatively, the receiving the at least one dimensional characteristic of an intended ground mount structure includes receiving a plurality of design constraints associated with the intended ground mount structure.

Additionally or alternatively, the capturing the imaging information of the environment includes capturing a panoramic image of a job site with in situ site conditions.

Additionally or alternatively, the method further comprises determining an azimuth from the captured imaging information and/or received location.

Additionally or alternatively, the method further comprises generating a shade analysis based on the captured imaging information and/or received location.

Additionally or alternatively, the method further comprises measuring slope and elevation using the AR-based spatial analysis system, and using the slope and elevation in the generating and displaying.

Additionally or alternatively, the method further comprises determining, by the computer system, a feasibility of the generated digital representation of the ground mount structure for construction at a job site.

Additionally or alternatively, the generating, by the computer system, the digital representation of the ground mount structure further comprises receiving, by the computer system, a first design constraint, and automatically calculating, by the computer system, design requirements of the generated digital representation of the ground mount structure using the first design constraint and the received location.

Additionally or alternatively, the automatically calculating the design requirements includes automatically estimating, by the computer system, a cost associated with the design requirements.

Additionally or alternatively, the first design constraint is a number of solar panels and the automatically calculating the design requirements includes automatically determining a structural configuration of the digital representation of the ground mount structure that satisfies load requirements to safely support the number of solar panels.

Additionally or alternatively, the displaying, by the display of the computer system, the environment with the generated digital representation of the ground mount structure further comprises enabling, by the computer system, user controllable adjustment of size, height, location, panel angle and/or rotation of the generated and displayed digital representation of the ground mount structure in the environment.

Additionally or alternatively, whenever a user adjusts size, height, location, panel angle and/or rotation of the generated and displayed digital representation of the ground mount structure, the computer system automatically updates design requirements and further automatically updates a cost estimate of the adjusted generated and displayed digital representation of the ground mount structure.

Additionally or alternatively, the method further comprises generating, by the computer system, digital representations of a plurality of ground mount structures for a plurality of solar panel arrays, and displaying, by the display of the computer system, the environment with the generated digital representations of the plurality of ground mount structures simultaneously.

Additionally or alternatively, the method further comprises overlaying, by the computer system, the generated digital representation of the ground mount structure onto satellite imagery of the environment.

Additionally or alternatively, the method further comprises analyzing, by the computer system, structural loading requirements of the generated digital representation of the ground mount structure, and generating, by the computer system, a bill of materials based on the structural loading requirements and a selected racking manufacturer.

Additionally or alternatively, the generating the shade analysis further comprises estimating, by the computer system, a production output of the solar panel array based on the shade analysis.

Additionally or alternatively, the method further comprises recording, by the computer system, trench line information including at least one of a trench line location, a distance along a trench path, and a grade along the trench path.

Additionally or alternatively, the method further comprises recording, by the computer system, at least one of a reference point or a reference line to establish a required array offset from at least one of a property boundary, a structure, a utility, or another feature in the environment.

Additionally or alternatively, the method further comprises receiving, by the user interface of the computer system, at least one design limit for the ground mount structure, the at least one design limit including at least one of a maximum array height or a minimum leading edge height, and enforcing, by the computer system, the at least one design limit during adjustment of parameters of the generated digital representation of the ground mount structure.

Additionally or alternatively, the receiving the at least one dimensional characteristic of an intended ground mount structure further comprises receiving, by the user interface of the computer system, a selection of a solar panel manufacturer and a solar panel model, and retrieving, by the computer system, panel dimensions from a database based on the selected solar panel manufacturer and solar panel model.

Additionally or alternatively, the receiving the at least one dimensional characteristic of an intended ground mount structure further comprises receiving, by the user interface of the computer system, custom panel dimensions including at least a length and a width of a solar panel not contained in a panel database.

Additionally or alternatively, the receiving the at least one dimensional characteristic of an intended ground mount structure further comprises receiving, by the user interface of the computer system, a selection of a racking manufacturer, and retrieving, by the computer system, racking specifications from a database based on the selected racking manufacturer.

Additionally or alternatively, the storing the generated digital representation of the ground mount structure further comprises storing, by the computer system, a location anchor associated with the generated digital representation of the ground mount structure at a geographic coordinate including a latitude, a longitude, and an altitude, and the loading the generated and stored digital representation of the ground mount structure further comprises scanning, by the camera of the computer system, the environment to detect visual landmarks, and re-localizing, by the computer system, the generated and stored digital representation of the ground mount structure at the geographic coordinate using a visual positioning system.

Additionally or alternatively, the method further comprises downloading, by the computer system, data from a server prior to the generating, and performing, by the computer system, the generating and the displaying without a network connection to the server.

Additionally or alternatively, the method further comprises transmitting, by the computer system, data associated with the generated digital representation of the ground mount structure to at least one recipient, the data including at least one of elevation data, landmark data, or image data.

Additionally or alternatively, the method further comprises generating, by the computer system, a price comparison between a plurality of solar panel configurations or a plurality of racking configurations.

Additionally or alternatively, the receiving the location in the environment further comprises receiving, by the computer system, enhanced positioning data from at least one of a Precise Point Positioning system or a Real-Time Kinematic system.

Additionally or alternatively, the receiving the at least one dimensional characteristic of an intended ground mount structure further comprises receiving, by the user interface of the computer system, a number of rows and a number of columns of solar panels, and calculating, by the computer system, overall array dimensions based on the number of rows, the number of columns, and panel dimensions.

Additionally or alternatively, the method further comprises receiving, by the user interface of the computer system, a selection of whether the ground mount structure is to follow a grade of a ground surface or hold level, and generating, by the computer system, the digital representation of the ground mount structure in accordance with the selection.

In another aspect, a computer program product is provided. The computer program product comprises one or more computer readable storage media having computer readable program code collectively stored on the one or more computer readable storage media. The computer readable program code is executed by one or more processors of a computer system to cause the computer system to perform a method for automatically generating a digital representation of a ground mount structure for a solar panel array. The method comprises receiving, by a user interface of the computer system, at least one dimensional characteristic of an intended ground mount structure. The method further comprises capturing, by a camera of the computer system, imaging information of an environment. The method further comprises receiving, by the computer system, a location in the environment. The method further comprises generating, by the computer system, the digital representation of the ground mount structure for the solar panel array using the received at least one dimensional characteristic and the received location. The method further comprises displaying, by a display of the computer system, the environment with the generated digital representation of the ground mount structure having the at least one dimensional characteristic and located at the received location.

In another aspect, a computer system is provided. The computer system comprises one or more processors. The computer system further comprises one or more computer readable storage media. The computer system further comprises computer readable code stored collectively in the one or more computer readable storage media, with the computer readable code including data and instructions to cause the one or more computer processors to perform a method for automatically generating a digital representation of a ground mount structure for a solar panel array. The method comprises receiving, by a user interface of the computer system, at least one dimensional characteristic of an intended ground mount structure. The method further comprises capturing, by a camera of the computer system, imaging information of an environment. The method further comprises receiving, by the computer system, a location in the environment. The method further comprises generating, by the computer system, the digital representation of the ground mount structure for the solar panel array using the received at least one dimensional characteristic and the received location. The method further comprises displaying, by a display of the computer system, the environment with the generated digital representation of the ground mount structure having the at least one dimensional characteristic and located at the received location.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 depicts a diagrammatic view of a solar panel ground mount structure design system in accordance with an embodiment;

FIG. 2 depicts a user interface of a computer system operating the solar panel ground mount structure design system to initiate a new project in accordance with an embodiment;

FIG. 3 depicts a user interface of a computer system operating the solar panel ground mount structure design system to select a solar panel in accordance with an embodiment;

FIG. 4 depicts a user interface of a computer system operating the solar panel ground mount structure design system to enter a solar panel array configuration in accordance with an embodiment;

FIG. 5 depicts a user interface of a computer system operating the solar panel ground mount structure design system to enter a solar panel array details in accordance with an embodiment;

FIG. 6 depicts a user interface of a computer system operating the solar panel ground mount structure design system for entering layout data in accordance with an embodiment;

FIG. 7 depicts a user interface of a computer system operating the solar panel ground mount structure design system to establish GPS bearing for solar panel array layout in accordance with an embodiment;

FIG. 8 depicts a user interface of a computer system operating the solar panel ground mount structure design system to set a solar panel array first corner in accordance with an embodiment;

FIG. 9 depicts a user interface of a computer system operating the solar panel ground mount structure design system to set a solar panel array second corner in accordance with an embodiment;

FIG. 10 depicts a user interface of a computer system operating the solar panel ground mount structure design system to depict solar panel array visualization in accordance with an embodiment;

FIG. 11 depicts a user interface of a computer system operating the solar panel ground mount structure design system to obtain contour points in accordance with an embodiment;

FIG. 12 depicts a user interface of a computer system operating the solar panel ground mount structure design system for azimuth layout data entry in accordance with an embodiment;

FIG. 13 depicts a user interface of a computer system operating the solar panel ground mount structure design system to display azimuth layout in accordance with an embodiment;

FIG. 14 depicts a flow chart of programmed steps of a computer system of a solar panel ground mount structure design system in accordance with an embodiment; and

FIG. 15 depicts a diagram of a computing device in accordance with an embodiment.

### DETAILED DESCRIPTION OF EMBODIMENTS OF THE INVENTION

In brief overview, embodiments of the present invention relate to a solar panel ground mount structure design system utilizing augmented reality-based spatial mapping and visualization (“AR”) capabilities of a computer system to design a ground mounted solar panel array. The system may include a mobile application operating on a computer system that may be a mobile computing device like a smartphone, a tablet, or the like. The mobile application may be a downloadable application or even a web application. The system may also include a server that may be coupled to the computer system via a network connection.

At its core, the system receives dimensional characteristics of an intended ground mount structure through a user interface, captures imaging information of an environment using a camera, and receives location data. Using this information, the system generates a digital representation of the ground mount structure and displays it within the captured environment, allowing users to visualize exactly how a solar panel array would appear at a specific location before any physical installation begins.

One significant capability involves azimuth measurement using GPS or GNSS technology rather than traditional compasses, which may be unreliable near power lines or ferromagnetic materials. The system may achieve azimuth accuracy based on the separation distance between benchmarks—for instance, when benchmarks are placed approximately 150 feet apart, accuracy within 3 degrees may be achieved approximately 97% of the time, improving to within 1.4 degrees at 200 feet separation. For applications requiring even greater precision, the system may integrate with Precise Point Positioning or Real-Time Kinematic systems.

Visualization lies at the heart of the system’s value proposition. Users may view the generated ground mount structure rendered in augmented reality, superimposed on the real environment as captured by the camera in real time. Alternatively, a virtual reality mode may present the design within a virtual representation of the environment. In either mode, users may interactively adjust parameters such as edge height, tilt angle, panel configuration, and whether the array should follow the natural grade of the terrain or remain level. As these adjustments occur, the system may automatically recalculate design requirements and update cost estimates in real time, providing immediate feedback on how changes affect both the structural design and project economics.

The system may also capture and utilize terrain data to inform the design process. Using the AR-based spatial analysis capabilities, users may measure slope and elevation across the installation site, record ground contours, and assess whether the terrain is suitable for array installation. This grade and contour information feeds directly into the generation of the digital representation, ensuring that the visualized structure accounts for actual site conditions.

Persistence and relocalization represent another key aspect of the system. Once a design is created and positioned within an environment, users may store the digital representation along with benchmark locations captured through imaging. When returning to the site—whether minutes or days later—the system may identify these benchmarks using the camera and image recognition to reload and display the stored design in precisely the same location. The system may leverage Visual Positioning System technology and Location Anchors to enable this persistent augmented reality experience, allowing placement at specific geographic coordinates with horizontal accuracy of approximately plus or minus one meter.

Beyond basic visualization, the system supports comprehensive project planning. Users may set and enforce design constraints such as maximum array height or minimum leading edge height, with the system preventing configurations that violate these limits during interactive adjustment. Multiple separate arrays may be designed and visualized simultaneously within the same environment, and array layouts may be overlaid onto satellite imagery for additional context and planning purposes.

The system may also assist with detailed project estimation and documentation. Based on the structural loading requirements of a designed array and a selected racking manufacturer, the system may generate a Bill of Materials identifying the components needed for construction. Cost analysis may be performed using user-defined pricing or database values, and price comparisons between different panel or racking configurations may be generated. When shade analysis is performed based on captured imaging and location data, the system may further estimate the production output of the solar panel array, helping users optimize placement for maximum energy generation.

Site documentation capabilities extend to recording trench line information—including locations, distances, and grades along planned trenching paths—as well as reference points or lines that establish required array offsets from property boundaries, structures, utilities, or other environmental features. This landmark and reference data may be stored with the project and transmitted to other stakeholders.

For panel and racking selection, the system may access a database containing physical dimensions for numerous solar panel models from various manufacturers. Users may select a manufacturer and model, with the system automatically retrieving length, width, and thickness specifications to calculate overall array dimensions based on the configured number of rows and columns. When a desired panel is not available in the database, users may input custom dimensions directly. Similarly, racking manufacturer selection may trigger retrieval of relevant racking specifications from a database.

Finally, the system accommodates real-world connectivity limitations common at remote installation sites. After downloading necessary data from the server, the computer system may perform design and visualization functions entirely offline, without requiring a network connection. Project data—including elevations, landmarks, photos, and design specifications—may later be transmitted to recipients via email or other means when connectivity is restored.

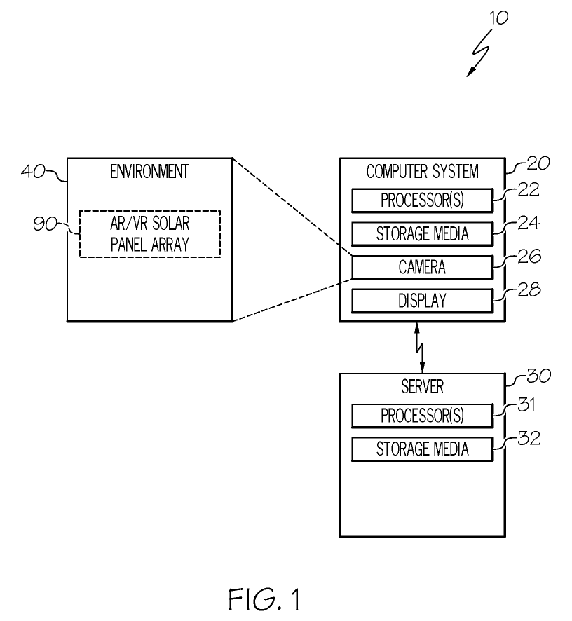

FIG. 1 depicts an embodiment of a solar panel ground mount structure design system 10. The system 10 may include a computer system 20 and a server 30, wherein the computer system 20 may be coupled to the server 30. This coupling may be a network connection, such as a wireless connection through an Internet connection provided by cellular network connection, a Wi-Fi connection, or the like, wherein the computer system 20 may communicate with and receive communication from the server 30. The computer system 20 may be a smartphone, a tablet, a laptop, or the like. The server 30, in some embodiments, may be a computer server or a cloud-based infrastructure architecture. The computer system 20 may include one or more processors 22, one or more computer readable storage media 24, a camera 26 and a display 28. The server 30 may include one or more processors 31, and one or more computer readable storage media 32.

The computer readable storage media 32 of the server 30 may store various data. The storage media 32 of the server 30 may store tables and other data utilized by the computer system 20 to perform the solar panel ground mount structure design. The storage media 32 of the server 30 may also store customer information, such as demographic information, location data, solar panel array data, a user of the computer system 20 and the user’s associated company, and so forth. This data is received from the computer system 20 as the computer system 20 operates to perform the solar panel ground mount structure design as described in this disclosure. The server 30 may operate and utilize the processor(s) 31 to aggregate and store the various data for each customer and each user in a database of the storage media 32 of the server 30.

A computer system 20 may be coupled to the server 30, and the computer system 20 may be programmed to download data from the server 30 needed to perform the solar panel ground mount structure design. The server 30 may be programmed to receive and store various data received from the computer system 20 as described previously. After the computer system 20 downloads the data from the server 30, the computer system 20 may be programmed to perform the solar panel ground mount structure design without the need of a network connection with the server 30. This allows the computer system 20 to operate in locations where a network connection is unreliable. However, it will be appreciated that the system 10 may include a light mobile application operating on the computer system 20, wherein some of the functionality described in this disclosure as performed by the computer system 20 may be performed on the server 30 with small amounts of data being sent from the computer system 20 to the server 30 and the server operating the programming and algorithms for performing certain functions of the solar panel ground mount structure design.

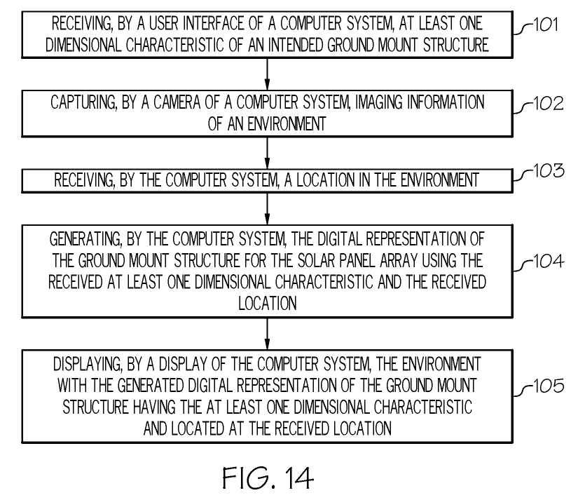

Accordingly, the computer system 20, referring additionally to FIG. 14, may comprise computer readable code (such as, but not limited to a mobile application) stored collectively in the one or more computer readable storage media 24, with the computer readable code including data and instructions to cause the one or more computer processors 22 to perform a method for automatically generating a digital representation of a ground mount structure for a solar panel array comprising receiving, by a user interface of the computer system 20, at least one dimensional characteristic of an intended ground mount structure (Step 101); capturing, by a camera 26 of the computer system 20, imaging information of an environment 40 (Step 102); receiving, by the computer system 20, a location in the environment 40 (Step 103); generating, by the computer system 20, the digital representation of the ground mount structure for the solar panel array using the received at least one dimensional characteristic and the received location (Step 104); and displaying, by a display 28 of the computer system 20, the environment 40 with the generated digital representation of the ground mount structure having the at least one dimensional characteristic and located at the received location (Step 105). The computer system 20, may also be programmed to take photos and screenshots of the area, calculate dimensions based on panel inputs, look up database of panels, look up racking style, generate rough order of magnitude cost estimates, perform price comparisons based on panels and racks, record landmarks (i.e. path for trench, obstructions, references), generate shading analysis, obtain ground contours, assess ground slope for feasibility, and e-mail data such as elevations, landmarks, photos, and the like.

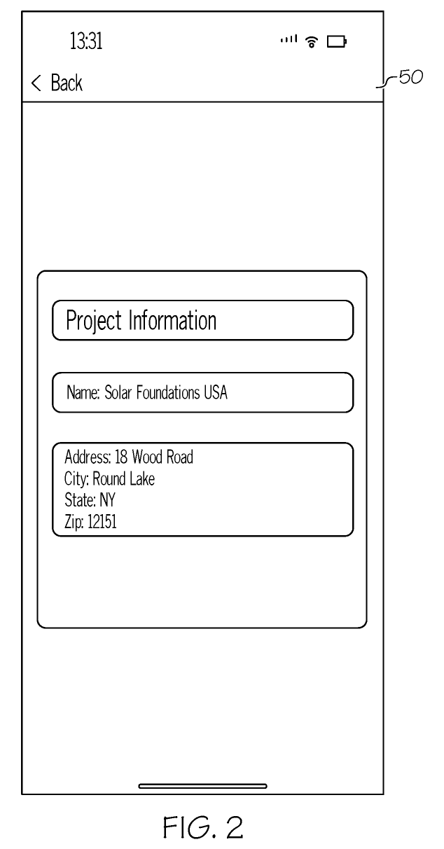

FIGS. 2-13 depict a user interface 50 on the computer system 20 during operation of the mobile application to perform the various functions according to an embodiment of the system 10. Operation of the mobile application on the computer system 20 displays the user interface 50 on the display 28 of the computer system 20. The user interface 50 provide various capabilities within the system 10 and provides the main component of user interaction with the system 10. For example, the user interface 50 may be depicted on a computer system 20 that allows for input through touch screen capabilities or through other input devices, such as, but not limited to, a keyboard, a mouse, a digital pen/pencil and the like. The user interface 50 may also provide instruction for the proper input and display of information associated with operation of the system 10 utilizing AR function of the computer system 20 to design a ground mounted solar panel array. In order to access and utilize the system 10, a user must enter, and the system must collect and record, for providing access to the user, user data that includes, without limitation, a company name, address and phone number and a user name and email address. Once this information is gathered, a user may be given login credentials for accessing the system 10 through a computer system 20.

FIG. 2 depicts the user interface 50 of the mobile application running on the computer system 20 as part of the solar panel ground mount structure design system 10. Operating the computer system 20, the user interface 50 may be utilized to enter project information for a particular site. The project information may include a project identifier, a project owner’s name, and address of the project, a phone number for the project owner and an email address for the project owner. This information may be stored in the storage medium 24 of the computer system 20. All other information obtained and stored by the computer system 20 may then be associated with the project information received. Additionally, the project data may include manual entry, data from look up tables and the like, for design parameters, including, but not limited to, wind speed, ground snow load, Risk Category, Exposure Category, and so forth.

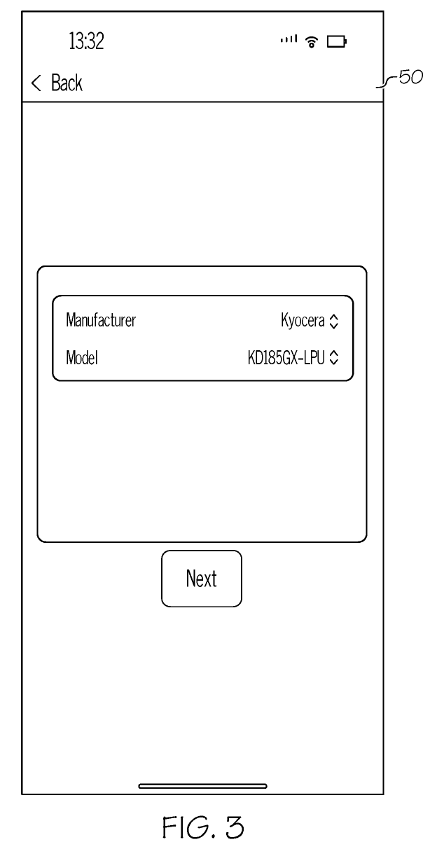

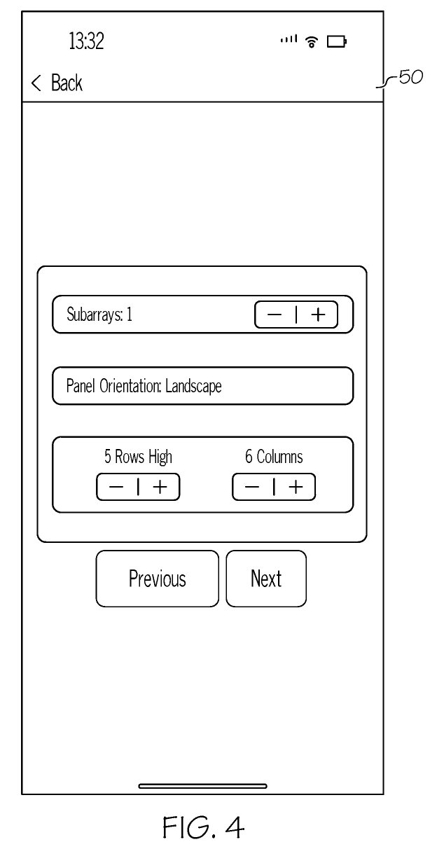

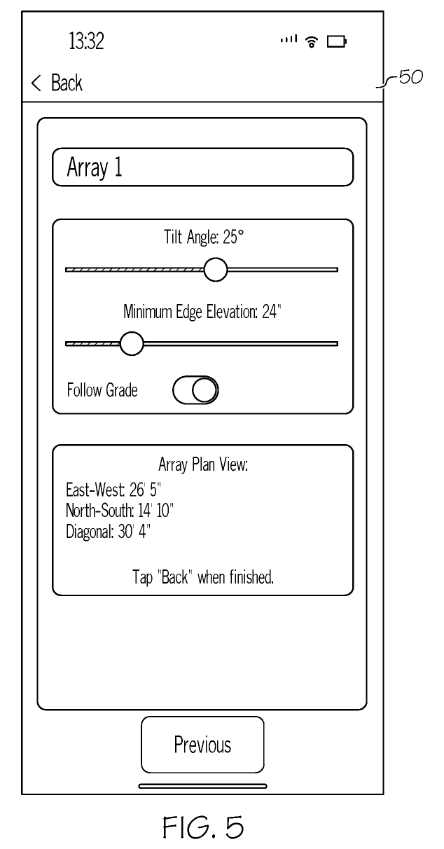

After the project information is received and stored, the user interface 20 may operate for calculating dimensions based on panel inputs. Through the use of the user interface 50, the application may be programmed to contain or look up a database of panel physical dimensions and calculate the overall array dimensions based on the number of rows and columns of panels. For example, if a user selects a panel with dimensions of 65 inches by 39 inches and configures an array with 5 rows and 6 columns in landscape orientation, the computer system 20 may calculate the overall array dimensions as approximately 26 feet 5 inches in the East-West direction and 14 feet 10 inches in the North-South direction. In order to accomplish this, the user interface 50 may operate for a panel selection, such as, but not limited to, drop down menus (or similar type of functional feature) for selecting a racking manufacturer and a solar panel array manufacturer and model, as shown in FIG. 3. Once the manufacturer and model are selected, the computer system 20 obtains the length, width, and thickness of the panel array from a database table and the user interface 50 may then depict input options for solar panel array configuration. This may include a number of subarrays, panel orientation, the number of rows, the number of columns, and the like, as depicted in FIG. 4, in order to calculate the total number of panels. In some embodiments, The user may also have the ability to enter a custom panel inputs with user input length width and thickness and total number of panels. The user interface 50 may then depict input options for array details, including, without limitation, tilt angle of the array, minimum edge elevation of the array and whether to have the array follow the grade of the ground surface the array is intended to be installed on, as shown in FIG. 5. For example, the tilt angle may be set to a value such as 25 degrees, and the minimum edge elevation may be set to a value such as 24 inches. Accordingly, by utilization of the user interface 50, the computer system 20 receives at least one dimensional characteristic of an intended ground mount structure, such as, but not limited to receiving one or more of a plurality of design constraints associated with the intended ground mount structure.

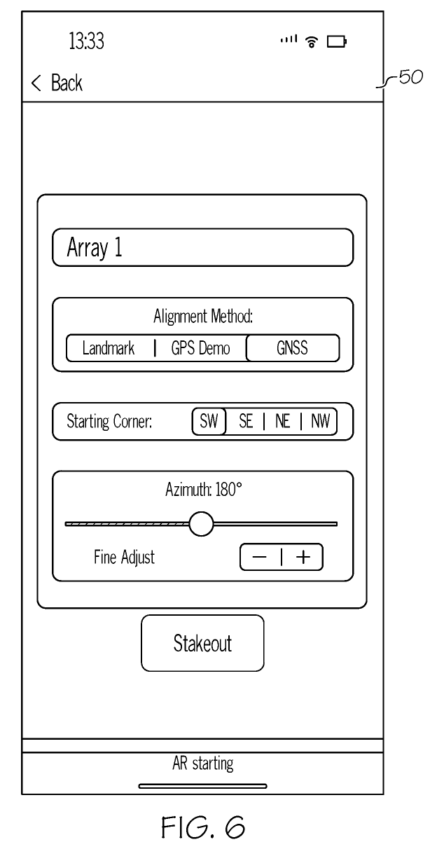

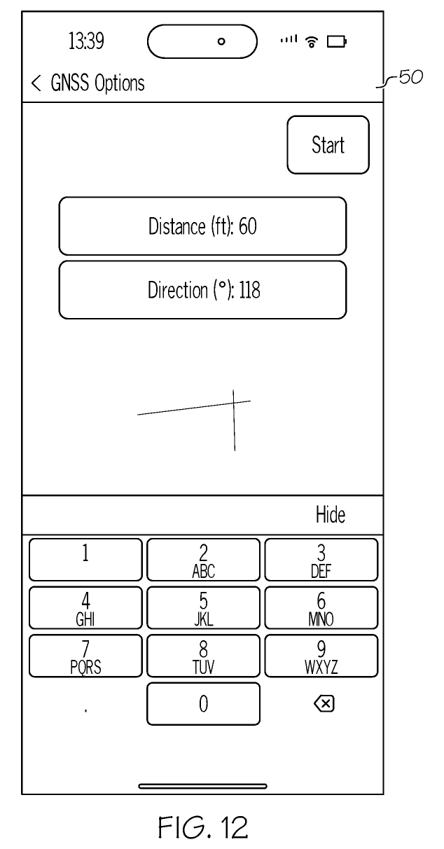

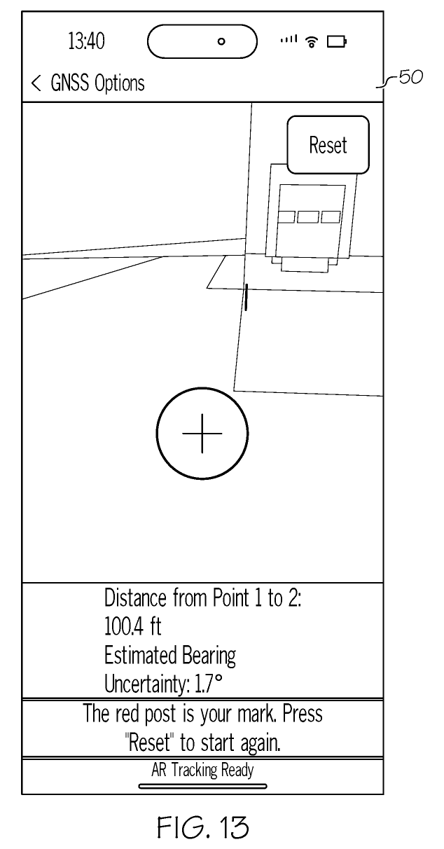

Once the user interface 50 is utilized to enter data for the array configuration and dimensions, the computer system 20 may used to measure azimuth. This may be performed through use of a compass user function or a GPS azimuth user function. While the compass user function is useable, at times compasses can be unreliable in the presence of magnetic field disturbances from power transmission or from ferromagnetic materials. Accordingly, embodiment of the system 10 operate using a GPS/GNSS azimuth user function. Referring to FIG. 6, the system 10 may utilize the user interface 50 as depicted, which operates the GPS technology of the computer system 20 to determine a location in the environment 40 and the azimuth. For example, the user interface 50 allows input of layout data for the array, including a selection of an alignment method (i.e., landmark, GPS, GNSS or the like), a starting corner of the array for measurement, and the azimuth. It is understood that a GPS system of the computer system 20 may provide GPS information of the computer system 20 and use the GPS information in determining directional bearings in the generating and displaying. The user interface 50 provides for a GNSS-based azimuth measurement that is independent of local conditions. The GNSS accuracy depends on the hardware, and embodiments of the system utilize GPS/GNSS functionality of the computer system, such as a smartphone or other device. Referring to FIGS. 12 and 13, the user interface 50 may be utilized by the computer system 20 to direct the user through azimuth layout data entry and display. For example, FIG. 12 directs a user through utilization of the user interface in conjunction with the camera 28 to enter a distance and a direction in order to start the azimuth layout. Once the data has been entered and the azimuth layout process initiated, the user interface 50 sets a visual indicator in augmented reality in the environment 40 captured by the camera 28 and displays the azimuth layout on the display 26. The system 10 may utilize other technologies in order to enhance accuracy, such as Precise Point Positioning that requires special receivers or Real-Time Kinematic that requires multiple devices and provides precise measurements down to the centimeter level.

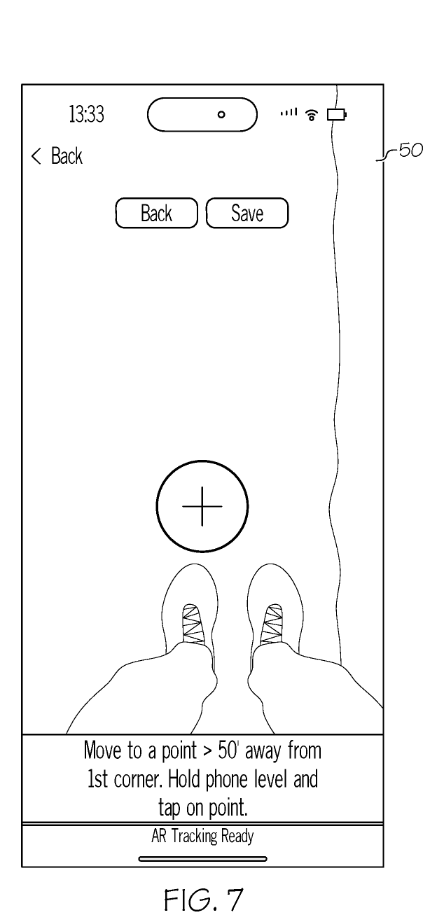

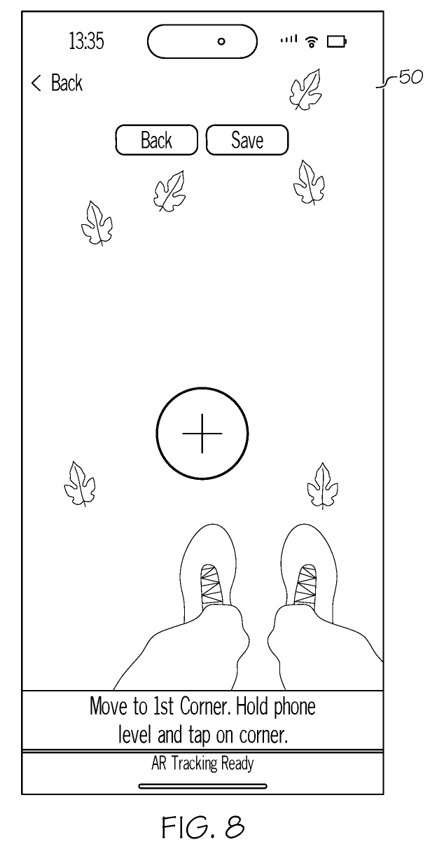

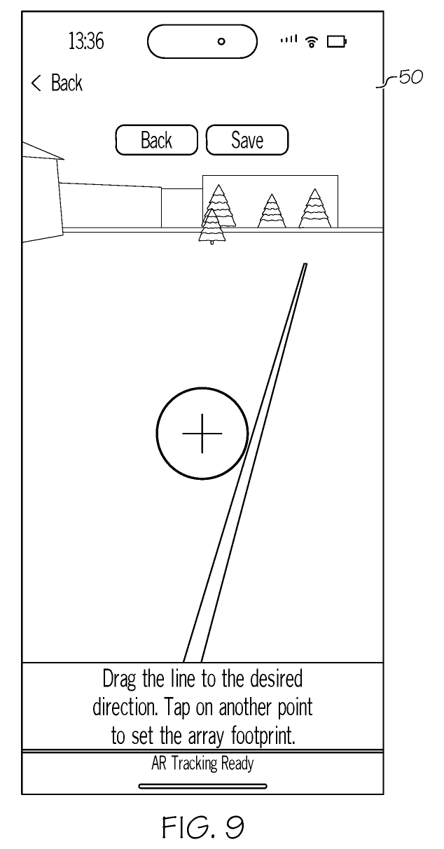

Once the alignment method, the starting corner of the array for measurement and the azimuth are selected, the computer system 20 may then continue to utilize the user interface 50, as depicted in FIGS. 7-9, to measure distances between points to set the ground mounted solar array footprint using AR-based spatial analysis system of the computer system 20. This allows for measurement accuracies that would support visualization of arrays and receiving of general positional reference data to be used in the generating the digital representation of the ground mount structure. This general positional reference data may be in the form of benchmarks, such as, but not limited to AR location, GNSS location, benchmark description, an image, or the like. The computer system 20 may be programmed to depict instructions on the display 28 of the computer system as part of the user interface 50 in order to guide a user of the computer system 20 in proper operation. FIG. 7 depicts the computer system 20 utilizing the user interface to guide the user through establishing a GPS bearing for the solar panel array layout. FIG. 8 depicts the user interface 50 operating on the computer system 20 to set the starting corner of the array, or first corner, relative to the benchmarks. Once the first or starting corner of the array is set, the user interface 50, as shown in FIG. 9, may be used to set a second corner that thereby sets the array footprint relative to the benchmarks, including the pile locations and south edge points of the array, all relative to the benchmarks.

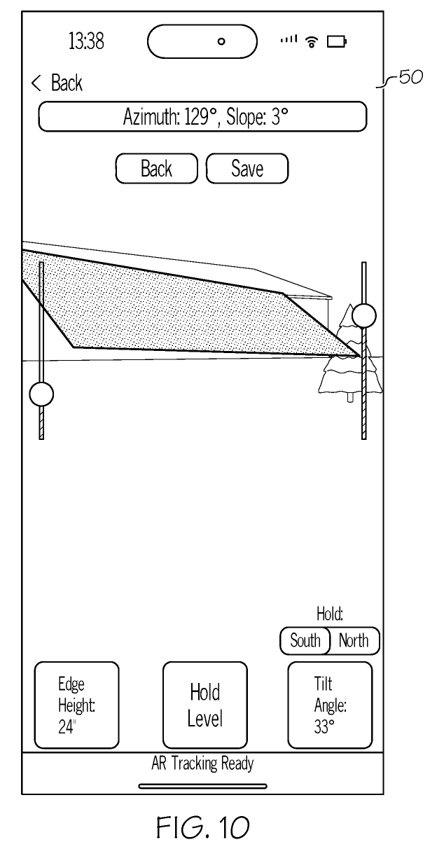

Once the array footprint is set, the computer system 20 may operate to generate the digital representation of the ground mount structure 90 and store the same in the storage medium 24. The computer system 20 may then load the generated and stored digital representation of the ground mount structure 90 at the received location within the environment and, through the user interface 50, display the environment 40 with the generated digital representation of the ground mount structure 90 by rendering a generated digital representation of the ground mount structure 90 in an augmented reality version of the environment 40 being captured in real time by the camera 26 and displayed by the display 28, as shown in FIG. 10. In embodiments, the storing, by the computer system 20, the generated digital representation of the ground mount structure 90 includes storing a benchmark location using the imaging captured by the camera 26, and the loading, by the computer system 20, the generated and stored digital representation of the ground mount structure 90 at the received location within the environment 40 includes identifying the at least one benchmark location associated with the generated digital representation of the ground mount structure 90 using the camera 26. Further, the loading, by the computer system 20, the generated and stored digital representation of the ground mount structure 90 at the received location within the environment 40 includes using the camera 26 and at least one image recognition system to automatically determine the received location. Further still, the loading, by the computer system 20, the generated and stored digital representation of the ground mount structure 90 at the received location within the environment 40 includes using a GPS system or an AR-based spatial analysis system to determine the received location. In these embodiments, the computer system 20 may, during the loading, determine the environment 40 and know exactly where to load and display the generated and stored digital representation of the ground mount structure 90 at the received location in the received location within the environment 40.

This augmented reality version of the environment 40 displaying the ground mounted solar panel array allows the computer system 20 to be moved around the environment 40 and based on the GPS location of the ground mounted solar panel array, visualize the augmented reality version of the ground mounted solar panel array in the environment 40 from all sides and visualize what it will actually look like in the selected space. The user interface 50 may include adjustable characteristics or array parameters. For example, the edge height, the tilt angle, and whether to follow the grade may be adjusted. For example, and without limitation, the user interface 50 may include a first slider adjuster to adjust the edge height value, the user interface 50 may include a second slider adjuster to adjust the tilt angle, and the user interface 50 may include a soft button to select whether to follow the grade or to hold the array level. It will be appreciated that the computer system 20 may utilize any means of adjustment. As these adjustments are made, the generated digital representation of the ground mount structure 90 displayed in augmented reality in the environment 40 is adjusted in real time and the visualization reflects the changes made. Once the user is satisfied with the ground mount solar panel array designed, it may be saved and stored in the storage media 24 of the computer system 20. Whenever a user adjusts size, height, location, panel angle and/or rotation of the generated and displayed digital representation of the ground mount structure, the computer system 20 is programmed to automatically update design requirements and further automatically updates a cost estimate of the adjusted generated and displayed digital representation of the ground mount structure 90.

In embodiments, displaying the environment 40 with the generated digital representation of the ground mount structure 90 further comprises rendering, by the computer system 20, the generated digital representation of the ground mount structure 90 in a virtual reality version of the environment 40 as the image information is captured in real time by the camera 26 and displayed by the display 28. This virtual reality version of the environment 40 displaying the ground mounted solar panel array allows the computer system 20 to be moved around the environment 40 and based on the GPS location of the ground mounted solar panel array, visualize the virtual reality version of the ground mounted solar panel array in the environment 40 from all sides and visualize what it will actually look like in the selected space. The user interface 50 may include adjustable characteristics or array parameters. For example, the edge height, the tilt angle, and selecting whether to follow the grade may be adjusted. For example, and without limitation, the user interface 50 may include a first slider adjuster to adjust the edge height value, the user interface 50 may include a second slider adjuster to adjust the tilt angle, and the user interface 50 may include a soft button to select whether to follow the grade or to hold the array level. As these adjustments are made, the generated digital representation of the ground mount structure 90 displayed in virtual reality in the environment 40 adjusted in real time and the visualization reflects the changes made. Once the user is satisfied with the ground mount solar panel array designed, it may be saved and stored in the storage media 24 of the computer system 20.

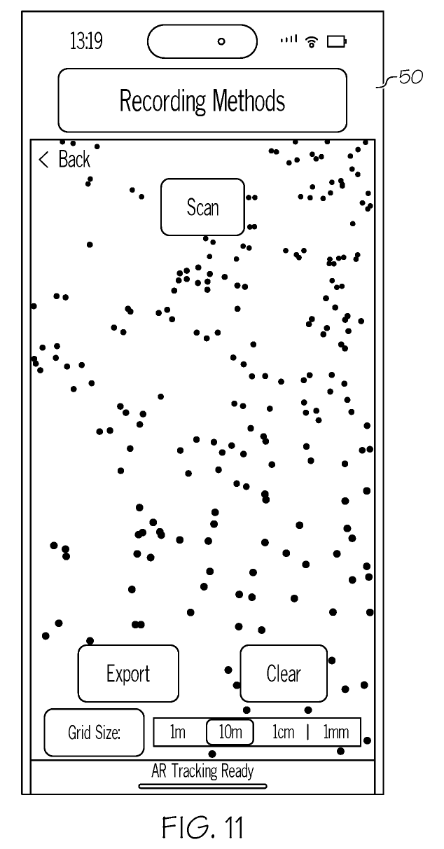

As shown in FIG. 11, the user interface 50 may also be used to measure contours, slope and elevation utilizing the AR-based spatial analysis system of the computer system 20. This allows for capturing the elevation data for multiple points in the area of the ground mounted solar panel array. The user interface 50 may utilize the AR-based spatial analysis system of the computer system 20 to record a mesh of ground contours to assist in job planning and for use in assessing the slope of the ground with respect to feasibility of installation work. The grade and contour information may be used in generating the digital representation of the ground mount structure. The computer system 20 has sufficient accuracy in elevation measurement to determine feasibility of array installations, relative heights for assisting in layouts, and so forth.

The computer system 20 may provide azimuth accuracy based on benchmark separation distance. When benchmarks are approximately 150 feet apart, the system 10 may achieve accuracy within 3 degrees approximately 97% of the time, and when benchmarks are approximately 200 feet apart, accuracy within 1.4 degrees may be achieved approximately 99% of the time. GNSS-based azimuth measurement may require a satellite acquisition time of approximately 90 seconds. Accuracy may be reduced in obstructed environments such as urban canyons or forested areas, though such environments are generally not well-suited for solar panel installations in any case.

Design constraints and limits represent an important aspect of the system’s functionality. Through the user interface 50, users may specify parameters such as maximum array height or minimum leading edge height. The computer system 20 may then enforce these limits dynamically—as a user adjusts structure parameters, the system may automatically prevent configurations that would exceed the defined constraints. This capability extends to designing multiple arrays: the user interface 50 may allow configuration of multiple separate ground mount structures within the environment 40, each with independent dimensional characteristics and locations. The computer system 20 may generate and display digital representations of all configured arrays simultaneously, and may further overlay these layouts onto satellite imagery to provide aerial context for the planned installation.

Detailed site documentation capabilities enhance the system’s utility for installation planning. Using the camera 26 and AR-based spatial analysis system, the computer system 20 may record trench line information including locations, distances, and grades along planned trenching paths. Reference points or lines may also be recorded to establish required array offsets from property boundaries, structures, utilities, or other environmental features. All landmark and reference data may be stored in the storage media 24 and associated with the relevant project information.

Project estimation features allow the computer system 20 to analyze structural loading requirements of a designed array and generate a Bill of Materials based on a selected racking manufacturer. Cost analysis may draw upon user-defined values or pricing data stored locally in the storage media 24 or retrieved from the server 30. When shade analysis is performed, the computer system 20 may further estimate production output of the solar panel array, taking into account captured imaging information, location data, and environmental factors affecting sunlight exposure.

Persistent augmented reality experiences are enabled through Visual Positioning System (VPS) technology and Location Anchors. The computer system 20 may combine AR tracking, GPS, compass data, and 3D map data to place the generated digital representation of the ground mount structure 90 at specific geographic coordinates—a particular latitude, longitude, and altitude. A user may then walk away from the location and return later, with the system re-localizing the digital representation accurately at the same position by scanning the visual environment through the camera 26 and detecting unique landmarks. Horizontal accuracy of approximately plus or minus one meter and vertical accuracy of approximately plus or minus one to two meters may be achieved, with effective relocalization possible across significant distances within the environment 40.

The system 10 organizes information through a detailed data structure. User data encompasses company information such as address and phone number alongside individual user details like name and e-mail address. Project data captures the project identifier, owner information, and contact details. Design parameters—including wind speed, ground snow load, Risk Category, and Exposure Category—may be obtained from data tables or input directly by an operator. App inputs cover racking manufacturer selection, panel manufacturer and model selection with automatic lookup of dimensions from a database, allowable rail locations, panel load specifications, total panel count, orientation settings, row and column counts, tilt angle, south edge height, azimuth, and whether to follow grade or hold level. Layout data tracks corner locations, pile locations, and south edge elevation points, all referenced to established benchmarks that include AR location, GNSS location, description, and associated imagery. This comprehensive data set may be stored in the storage media 24 and transmitted to the server 30 for centralized storage in the storage media 32.

When a desired solar panel is not available in the system’s database, the user interface 50 provides custom panel input capability. Users may enter panel dimensions including length, width, and thickness directly, and the computer system 20 may use these custom specifications when calculating overall array dimensions and generating the digital representation of the ground mount structure 90.

It will be understood that other features not shown may be performed. For example, the computer system 20 may operate to take photos and screenshots that can be uploaded to the server 30 for storage and aggregation with the customer information, such as, but not limited to, capturing the imaging information of the environment 40 including capturing a panoramic of a job site with in situ site conditions. The computer system 20 may generate rough order of magnitude (ROM) cost estimates, wherein the computer system 20 may have access to a database of pricing associated with panels and racks, thereby allowing ROM cost estimates to be generated. With this information, the system would also allow for price comparisons. The computer system 20 may record landmarks (path for trench, obstructions, references) utilizing the AR and photography capabilities of computer system, wherein the application may record the location and configuration of landmarks, utility paths, potential obstructions, and the like.

Another feature not shown that may be performed is utilization of the shade analysis user interface 70. This shade analysis user interface 70 uses photography, AR-based spatial analysis system, and GNSS technology to evaluate how shadows cast by surrounding objects such as, without limitation, trees, buildings, or terrain will affect the amount of sunlight reaching the solar panels. This is valuable information to determine the effectiveness of the solar panel array in the selected area and can help determine if that particular location is the best option.

All of this information may be emailed through the system 10 utilizing the mobile application operating on the computer system 20 for such purposes and emailing elevations, landmarks, photos and so forth to the customer, the company of the user and any other email address desired.

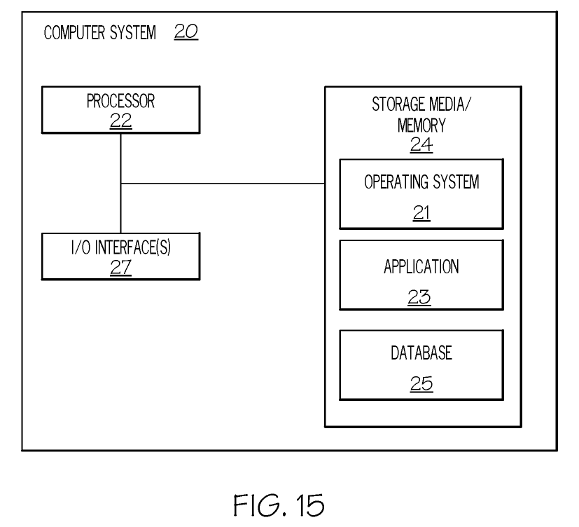

FIG. 15 depicts a diagram of an example computing system 20, according to an example embodiment. As shown, the computing system 20 includes one or more processors 22, non-transitory computer readable medium or memory 24, I/O interface devices 27 (e.g., wireless communications, etc.) and a network interface 27. The computer readable medium or memory 24 may include an operating system 21, running one or more software applications 23 in accordance with the systems and methods described herein.

In operation, the processor 22 may execute the application 23 stored in the computer readable medium 24. The application 23 may include software instructions that, when executed by the processor, cause the processor to perform operations for designing a ground mounted solar panel array, as described and shown in the various Figures.

The application program 23 may operate in conjunction with the data section 25 and the operating system 21. The device 20 may communicate with other devices (e.g., a wireless access point) via the I/O interfaces 27.

The solar panel ground mount structure design system described herein addresses numerous technical challenges that have historically complicated the design and installation of ground-mounted solar arrays. Traditional compass-based azimuth measurement may be unreliable in the presence of magnetic field disturbances from power transmission lines or ferromagnetic materials commonly found at installation sites. By utilizing GNSS-based azimuth measurement that operates independently of local magnetic conditions, the system may achieve consistent accuracy regardless of environmental interference. The system may also address the frequent failure to properly evaluate site slopes during conventional design processes—a shortcoming that may lead to costly surprises during installation. Through AR-based spatial analysis capabilities, users may measure slope, elevation, and ground contours directly on-site, enabling informed feasibility assessments before construction begins.

Stakeout dimensioning and the problem of vanishing corner stakes present additional challenges in conventional workflows. Physical stakes may be displaced, obscured, or removed between site visits, requiring repeated surveying work. The system may overcome this limitation through persistent augmented reality visualization using Visual Positioning System technology and Location Anchors, allowing stored designs to be accurately re-localized at their original geographic coordinates upon return to the site. This persistence may extend across days or weeks, with the system identifying visual landmarks through the camera to restore the digital representation precisely where it was originally placed. Furthermore, conventional design processes may lack effective on-site visualization capabilities, forcing designers and customers to imagine how a proposed array would appear in the actual environment. The augmented and virtual reality rendering capabilities of the system may allow stakeholders to view photorealistic representations of the proposed structure superimposed on the real environment in real time, facilitating more informed decision-making.

Configuration cost variability represents another challenge addressed by the system. As design parameters change during the planning process, the cost implications of those changes may be difficult to track using conventional manual methods. The system may automatically update design requirements and cost estimates whenever a user adjusts parameters such as size, height, location, panel angle, or rotation, providing immediate feedback on project economics. The ability to generate price comparisons between different panel or racking configurations, along with Bill of Materials generation based on structural loading analysis, may further streamline the estimation process. By integrating GPS capabilities, AR-based spatial analysis, panoramic imaging, panel and racking databases, cost estimation, shade analysis with production output estimation, and comprehensive site documentation into a single mobile application, the system may replace the fragmented collection of manual processes and disparate tools that characterize conventional ground mount solar array design. The result may be a more efficient, accurate, and accessible design workflow that operates effectively even at remote sites without network connectivity.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a "circuit," "module" or "system." Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like, conventional procedural programming languages, such as the "C" programming language or similar programming languages, declarative programming languages, such as Swift or other similar programming languages. The program code may be executed entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A method for automatically generating a digital representation of a ground mount structure for a solar panel array, comprising:
receiving, by a user interface of a computer system, at least one dimensional characteristic of an intended ground mount structure;
capturing, by a camera of the computer system, imaging information of an environment;
receiving, by the computer system, a location in the environment;
generating, by the computer system, the digital representation of the ground mount structure for the solar panel array using the received at least one dimensional characteristic and the received location; and
displaying, by a display of the computer system, the environment with the generated digital representation of the ground mount structure having the at least one dimensional characteristic and located at the received location.

2. The method of claim 1, wherein receiving the location in the environment further comprises:
receiving, by a GPS system of the computer system, GPS information of the computer system; and
using, by the computer system, the received GPS information in determining directional bearings in the generating and displaying.

3. The method of claim 1, wherein generating the digital representation of the ground mount structure further comprises:
using, by the computer system, an AR-based spatial analysis system.

4. The method of claim 1, wherein the displaying the environment with the generated digital representation of the ground mount structure further comprises:
rendering, by the computer system, the generated digital representation of the ground mount structure in an augmented reality version of the environment being captured in real time by the camera and displayed by the display.

5. The method of claim 1, wherein the displaying the environment with the generated digital representation of the ground mount structure further comprises:
rendering, by the computer system, the generated digital representation of the ground mount structure in a virtual reality version of the environment as the imaging information is captured in real time by the camera.

6. The method of claim 1, further comprising:
receiving, by the computer system, grade and contour information of the environment; and
using, by the computer system, the grade and contour information in generating the digital representation of the ground mount structure.

7. The method of claim 1, further comprising:
storing, by the computer system, the generated digital representation of the ground mount structure;
loading, by the computer system, the generated and stored digital representation of the ground mount structure at the received location within the environment; and
displaying, by the display of the computer system, the environment with the generated and stored digital representation of the ground mount structure at the received location.

8. The method of claim 7, wherein:
the storing, by the computer system, the generated digital representation of the ground mount structure includes storing a benchmark location using the imaging captured by the camera, and
the loading, by the computer system, the generated and stored digital representation of the ground mount structure at the received location within the environment includes identifying the at least one benchmark location associated with the generated digital representation of the ground mount structure using the camera.

9. The method of claim 7, wherein the loading, by the computer system, the generated and stored digital representation of the ground mount structure at the received location within the environment includes using the camera and at least one image recognition system to automatically determine the received location.

10. The method of claim 7, wherein the loading, by the computer system, the generated and stored digital representation of the ground mount structure at the received location within the environment includes using a GPS system or an AR-based spatial analysis system to determine the received location.

11. The method of claim 1, wherein receiving, by the computer system, the location in the environment further comprises:
receiving, by the computer system, general positional reference data used in the generating the digital representation of the ground mount structure.

12. The method of claim 1, wherein the receiving the at least one dimensional characteristic of an intended ground mount structure includes receiving a plurality of design constraints associated with the intended ground mount structure.

13. The method of claim 1, wherein the capturing the imaging information of the environment includes capturing a panoramic image of a job site with in situ site conditions.

14. The method of claim 1, further comprising:
determining an azimuth from the captured imaging information and/or received location.

15. The method of claim 1, further comprising generating a shade analysis based on the captured imaging information and/or received location.

16. The method of claim 3, further comprising:
measuring slope and elevation using the AR-based spatial analysis system; and
using the slope and elevation in the generating and displaying.

17. The method of claim 1, further comprising:
determining, by the computer system, a feasibility of the generated digital representation of the ground mount structure for construction at a job site.

18. The method of claim 1, wherein the generating, by the computer system, the digital representation of the ground mount structure further comprises:
receiving, by the computer system, a first design constraint; and
automatically calculating, by the computer system, design requirements of the generated digital representation of the ground mount structure using the first design constraint and the received location.

19. The method of claim 18, wherein the automatically calculating the design requirements includes automatically estimating, by the computer system, a cost associated with the design requirements.

20. The method of claim 18, wherein the first design constraint is a number of solar panels and wherein the automatically calculating the design requirements includes automatically determining a structural configuration of the digital representation of the ground mount structure that satisfies load requirements to safely support the number of solar panels.

21. The method of claim 1, wherein the displaying, by the display of the computer system, the environment with the generated digital representation of the ground mount structure further comprises:
enabling, by the computer system, user controllable adjustment of size, height, location, panel angle and/or rotation of the generated and displayed digital representation of the ground mount structure in the environment.

22. The method of claim 21, wherein whenever a user adjusts size, height, location, panel angle and/or rotation of the generated and displayed digital representation of the ground mount structure, the computer system automatically updates design requirements and further automatically updates a cost estimate of the adjusted generated and displayed digital representation of the ground mount structure.

23. A computer program product comprising:
one or more computer readable storage media having computer readable program code collectively stored on the one or more computer readable storage media, the computer readable program code being executed by one or more processors of a computer system to cause the computer system to perform a method for automatically generating a digital representation of a ground mount structure for a solar panel array comprising:
receiving, by a user interface of the computer system, at least one dimensional characteristic of an intended ground mount structure;
capturing, by a camera of the computer system, imaging information of an environment;
receiving, by the computer system, a location in the environment;
generating, by the computer system, the digital representation of the ground mount structure for the solar panel array using the received at least one dimensional characteristic and the received location; and
displaying, by a display of the computer system, the environment with the generated digital representation of the ground mount structure having the at least one dimensional characteristic and located at the received location.

24. A computer system, comprising:
one or more processors;
one or more computer readable storage media; and
computer readable code stored collectively in the one or more computer readable storage media, with the computer readable code including data and instructions to cause the one or more computer processors to perform a method for automatically generating a digital representation of a ground mount structure for a solar panel array comprising:
receiving, by a user interface of the computer system, at least one dimensional characteristic of an intended ground mount structure;
capturing, by a camera of the computer system, imaging information of an environment;
receiving, by the computer system, a location in the environment;
generating, by the computer system, the digital representation of the ground mount structure for the solar panel array using the received at least one dimensional characteristic and the received location; and
displaying, by a display of the computer system, the environment with the generated digital representation of the ground mount structure having the at least one dimensional characteristic and located at the received location.
